(19) United States
(12) Patent Application Publication
(10) Pub. No.: US 2023/0316323 A1
(43) Pub. Date: Oct. 5, 2023

(54) SERVER PERFORMING BENEFIT PROVISION PROCESS TO PROVIDE BENEFIT BY USING VARIABLE RATE

(71) Applicant: Brother Kogyo Kabushiki Kaisha, Nagoya (JP)

(72) Inventor: Yutaka TAKIJIRI, Nagoya (JP)

(73) Assignee: Brother Kogyo Kabushiki Kaisha, Nagoya (JP)

(21) Appl. No.: 18/187,780

(22) Filed: Mar. 22, 2023

(30) Foreign Application Priority Data
Mar. 30, 2022 (JP) 2022-055858

(51) Int. Cl. G06Q 30/0226; G06K 15/02; H04N 1/34

(52) U.S. Cl. CPC G06Q 30/0233; G06K 15/1823; H04N 1/346

(57) ABSTRACT

In a server, a storage stores correlation information correlating a specific amount of print resources with a specific price. The computer instructs a printing device to execute printing, and acquires usage information for a user of the printing device from the printing device. A computer performs one of a first and second processes. The first process includes a process to determine a first variable rate which varies between the first usage state and the second usage state, and a process to award number of points calculated on the basis of the first variable rate and the specific price. The second process includes a process to determine a second variable rate which varies between the first usage state and the second usage state, and a process to provide the user with an amount of reward calculated on the basis of the second variable rate and the specific price.

### REFERENCE TO RELATED APPLICATIONS

This application claims priority from Japanese Patent Application No. 2022-055858 filed on Mar. 30, 2022. The entire content of the priority application is incorporated herein by reference.

### BACKGROUND ART

One technology known in the art allocates points to users of an image-forming device, for example, and then adds or subtracts points for each user on the basis of the state of the device at the beginning of usage and the amount of paper and the like used in printing. This conventional technology encourages the user to print in a more environmentally friendly manner by subtracting points when printing is started while the fixing roller is cold or when toner consumption increases and by adding points when the image-forming device enters the sleep mode, for example.

### DESCRIPTION

Generally, when users use awarded points for their own benefit, the awarded points are redeemed in some form that will benefit the respective user. Therefore, in order to increase and decrease points to encourage users to print in the most favorable manner, it is conceivable to adjust (increase/decrease) the user's benefit when the points are redeemed rather than adjusting the number of points when the points are awarded. Further, it is conceivable to adjust (increase/decrease) the number of points at the time of point allocation and to adjust the user's benefit at the time of point redemption in order to provide even more detailed benefits to users.

In recent years, the requirements and printing styles of users have become more widely varied. Some users print large quantities for business use, while others print relatively small quantities for home use. Some users print mainly photographs and require high image quality, and while others print mainly documents and have little concern for image quality. Thus, when performing the above adjustments to increase or decrease points, it is desirable to provide more detailed benefits to users to meet such diverse styles of use.

The conventional technology described above gives no particular consideration to these matters, only adding or subtracting points according to the conditions each time a print is executed. Thus, the conventional technology cannot provide each user with benefits that flexibly meet the diverse printing styles and requirements of the user.

In view of the foregoing, it is an object of the present disclosure to provide a server capable of flexibly implementing a benefit provision service based on usage information for users of a printing device.

In order to attain the above and other object, the present disclosure provides a server. The server includes a communication interface, a storage, and a computer. The communication interface is configured to communicate with a printing device. The storage stores correlation information correlating a specific amount of print resources with a specific price for which the specific amount can be purchased. The specific amount is represented in specific units. The print resources are related to a print medium. The computer is configured to perform: a printing process to instruct the printing device to execute printing on a specific unit basis; acquiring usage information for a user of the printing device from the printing device via the communication interface, the usage information indicating one of a plurality of usage states of the printing device including a first usage state and a second usage state different from the first usage state; and a benefit provision process to perform at least one of a first process and a second process. The first process includes: a first determining process to determine a first variable rate so that the first variable rate varies between when the usage information indicates the first usage state and when the usage information indicates the second usage state; and an awarding process to award number of points calculated on the basis of a product of the first variable rate and the specific price when the specific amount of print resources is purchased for the specific price. The second process includes: a second determining process to determine a second variable rate so that the second variable rate varies between when the usage information indicates the first usage state and when the usage information indicates the second usage state; and a providing process to provide the user with an amount of reward calculated on the basis of a product of the second variable rate and the specific price when the specific amount of print resources is purchased for the specific price.

According to another aspect, the disclosure provides a method for a print management system storing correlation information correlating a specific amount of print resources with a specific price for which the specific amount can be purchased. The specific amount is represented in specific units. The print resources are related to a print medium. The print management system performs a printing process to instruct the printing device to execute printing on a specific unit basis. The method includes: acquiring usage information for a user of the printing device from the printing device via the communication interface, the usage information indicating one of a plurality of usage states of the printing device including a first usage state and a second usage state different from the first usage state; and a benefit provision process to perform at least one of a first process and a second process. The first process includes: a first determining process to determine a first variable rate so that the first variable rate varies between when the usage information indicates the first usage state and when the usage information indicates the second usage state; and an awarding process to award number of points calculated on the basis of a product of the first variable rate and the specific price when the specific amount of print resources is purchased for the specific price. The second process includes: a second determining process to determine a second variable rate so that the second variable rate varies between when the usage information indicates the first usage state and when the usage information indicates the second usage state; and a providing process to provide the user with an amount of reward calculated on the basis of a product of the second variable rate and the specific price when the specific amount of print resources is purchased for the specific price.

According to still another aspect, the disclosure provides a server. The server includes a communication interface, a storage, and a computer. The communication interface is configured to communicate with a printing device. The storage stores: correlation information correlating a specific amount of print resources with a specific price for which the specific amount can be purchased, the print resources being related to a print medium; and information on a print resource balance indicating an accumulated amount of print resources available in the printing device, wherein when the specific amount of print resources is purchased, the purchased specific amount is added to the print resource balance. The computer is configured to perform: a printing process to instruct the printing device to execute printing on number of printing media while withdrawing an amount of print resources corresponding to the number of printing media from the print resource balance; acquiring usage information for a user of the printing device from the printing device via the communication interface, the usage information indicating one of a plurality of usage states of the printing device including a first usage state and a second usage state different from the first usage state; and a benefit provision process to perform at least one of a first process and a second process. The first process includes: a first determining process to determine a first variable rate so that the first variable rate varies between when the usage information indicates the first usage state and when the usage information indicates the second usage state; and an awarding process to award number of points calculated on the basis of a product of the first variable rate and the specific price when the specific amount of print resources is purchased for the specific price. The second process includes: a second determining process to determine a second variable rate so that the second variable rate varies between when the usage information indicates the first usage state and when the usage information indicates the second usage state; and a rewarding process to provide the user with an amount of reward calculated on the basis of the second variable rate.

In the above structures, a benefit provision service on the basis of the user's usage information can be flexibly performed on the basis of the usage information indicating how the printing device is used.

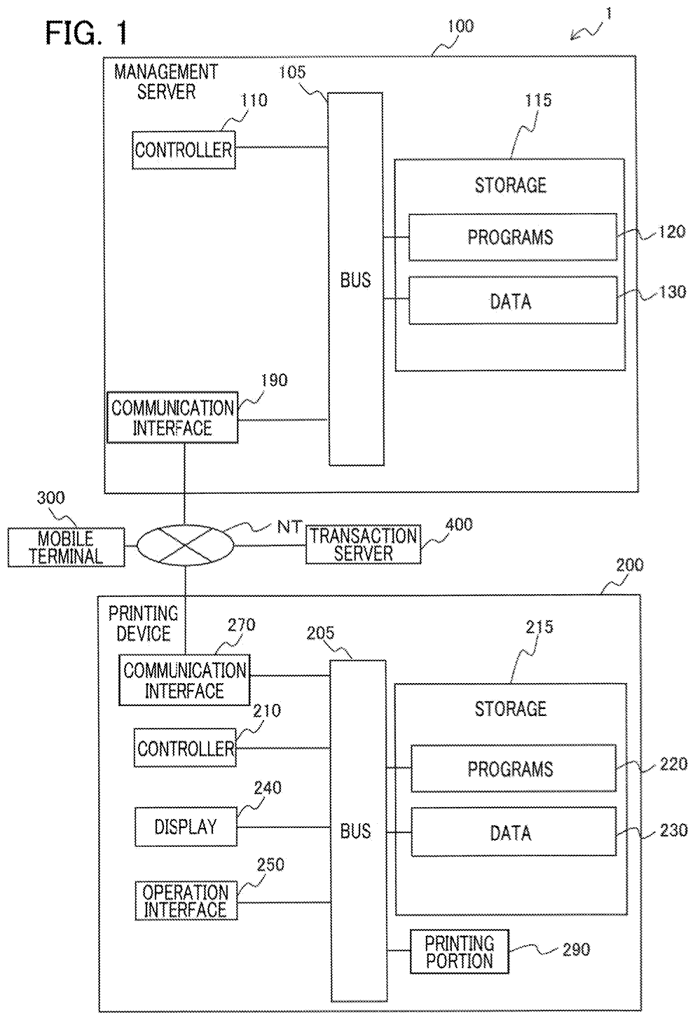

FIG. 1 is a block diagram illustrating an overall configuration of a printing service provision system.

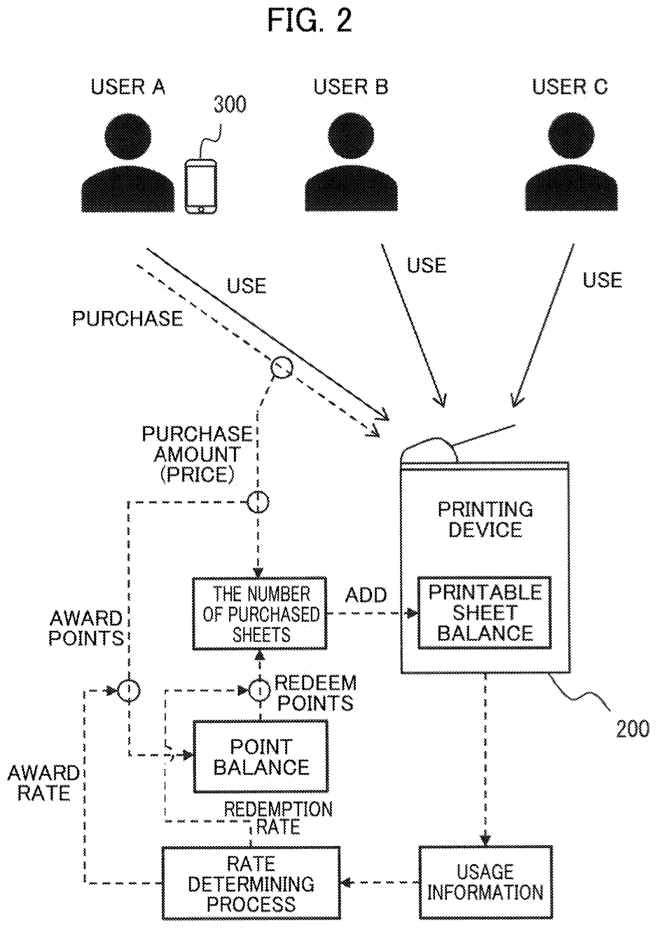

FIG. 2 is a schematic diagram illustrating an example of a prepaid printing service provided by the printing service provision system.

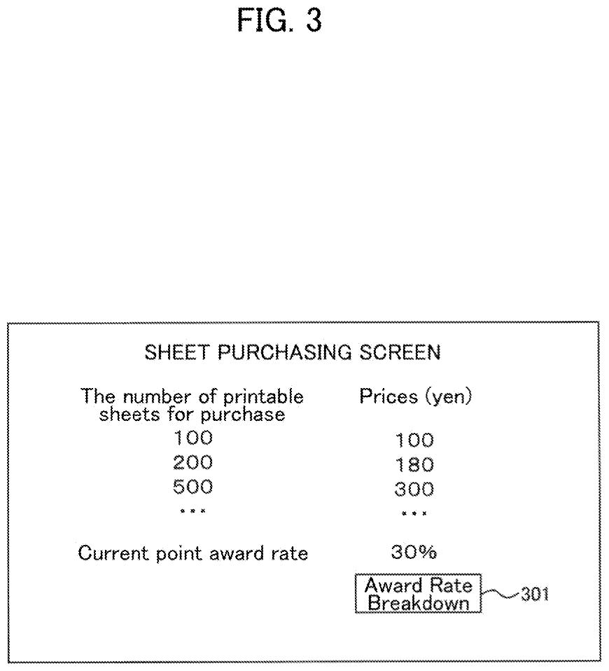

FIG. 3 is an explanatory diagram illustrating an example of a sheet purchasing screen for purchasing printable sheets displayed on a touchscreen of a mobile terminal.

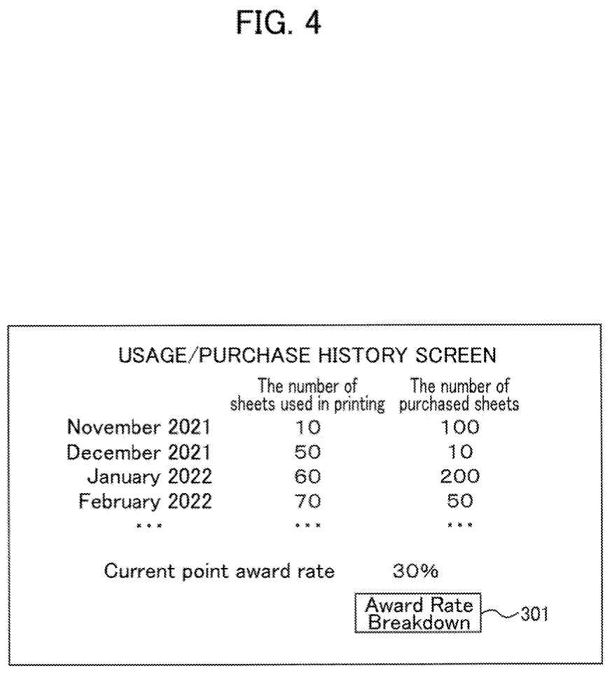

FIG. 4 is an explanatory diagram illustrating an example of a usage/purchase history screen showing a usage history of the numbers of sheets printed on a printing device and a purchase history of purchasing printable sheets displayed on the touchscreen of the mobile terminal.

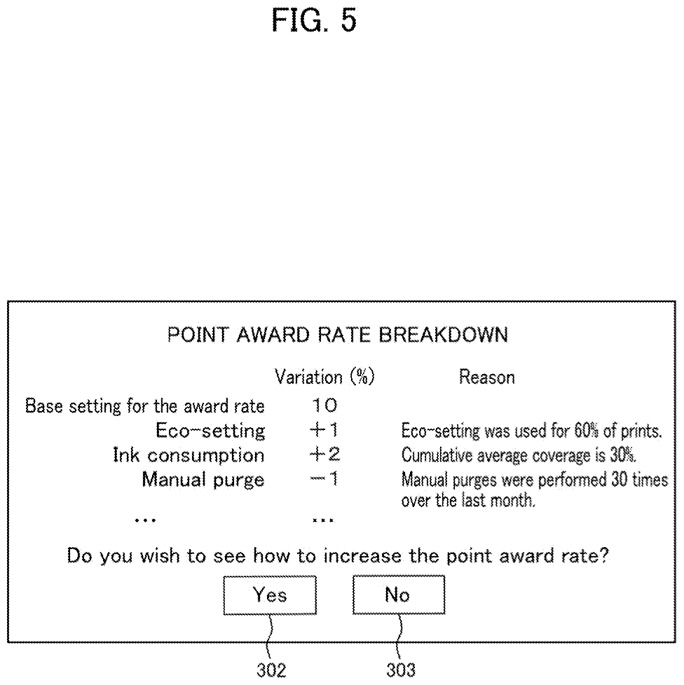

FIG. 5 is an explanatory diagram illustrating an example of a point award rate breakdown screen showing a breakdown of the award rate displayed on the touchscreen of the mobile terminal.

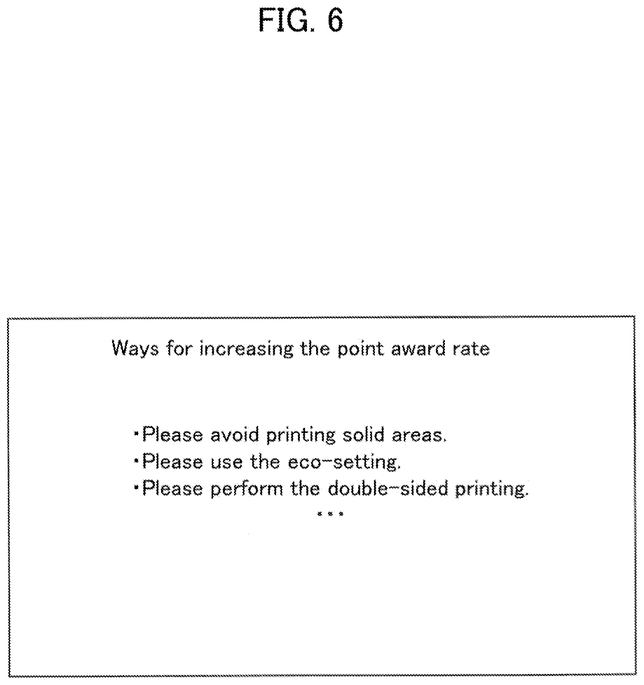

FIG. 6 is an explanatory diagram illustrating an explanatory diagram illustrating a screen showing ways that the user can increase the point award rate displayed on the touchscreen of the mobile terminal.

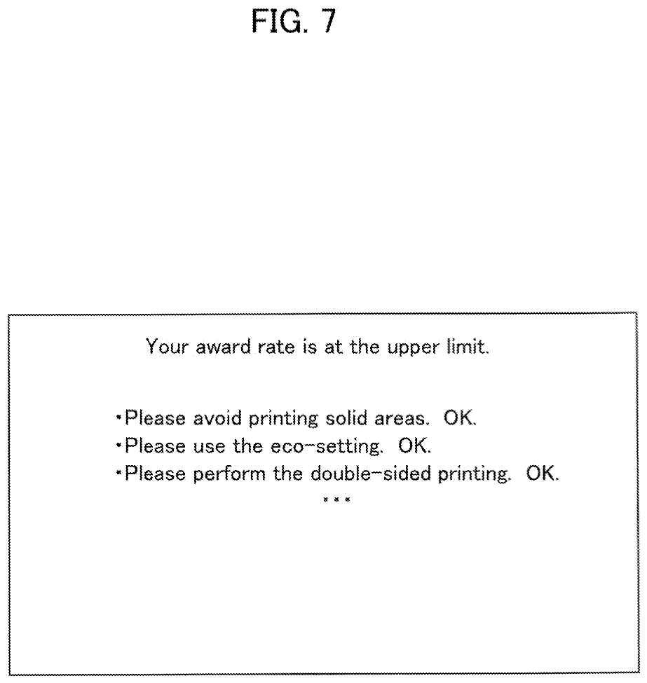

FIG. 7 is an explanatory diagram illustrating a sample screen displayed when the user operates a Yes button in the point award rate breakdown screen of FIG. 5 and the award rate is at the upper limit.

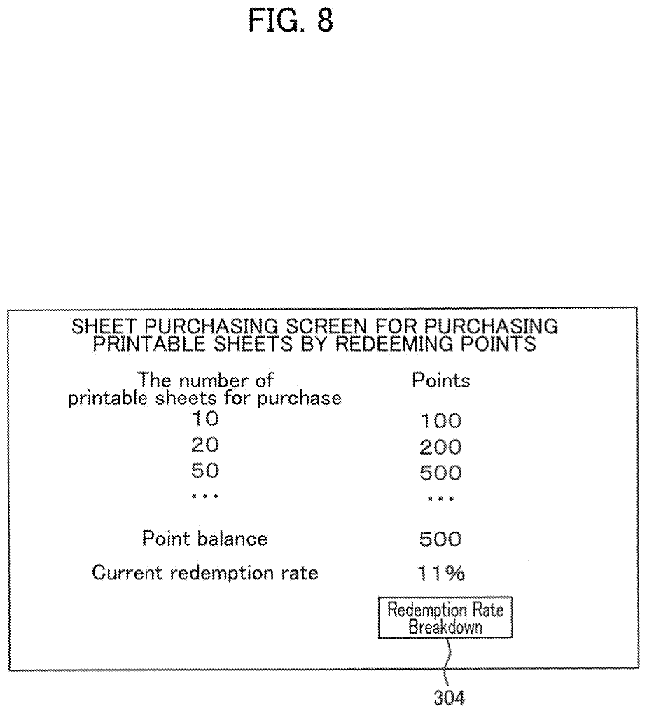

FIG. 8 is an explanatory diagram illustrating an example of a sheet purchasing screen for purchasing printable sheets by redeeming points.

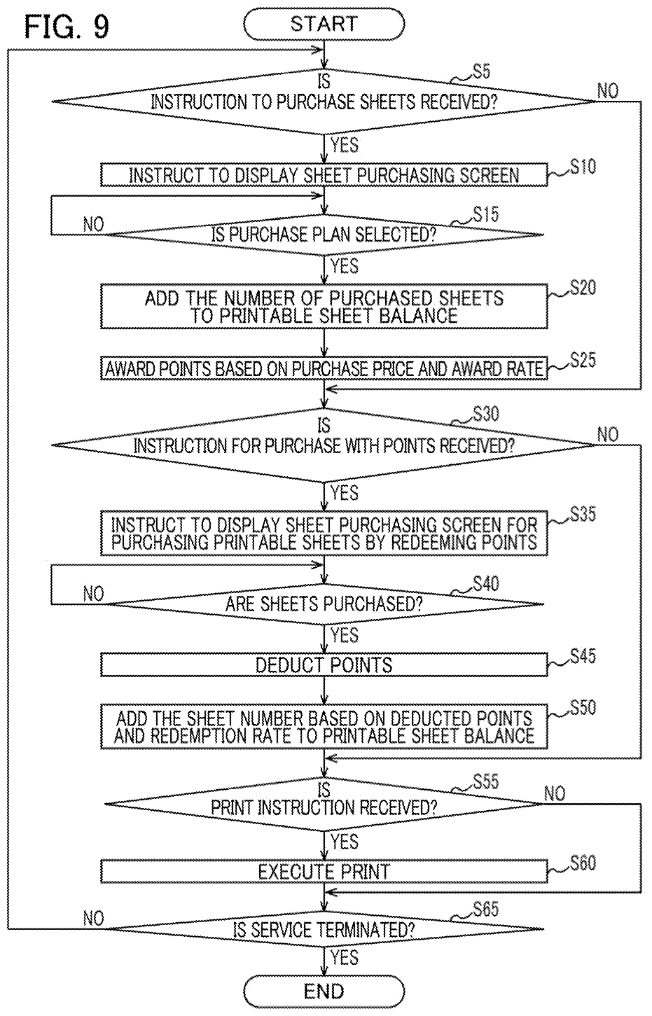

FIG. 9 is a flowchart illustrating an example of a control process executed by a controller of a management server.

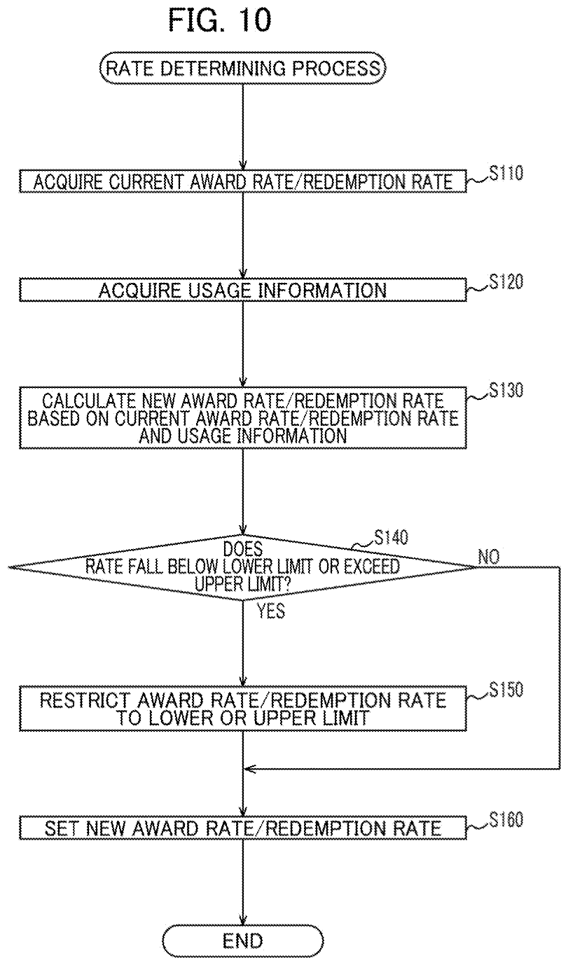

FIG. 10 is a flowchart illustrating an example of a rate determining process for setting an award rate/redemption rate executed by the controller of the management server.

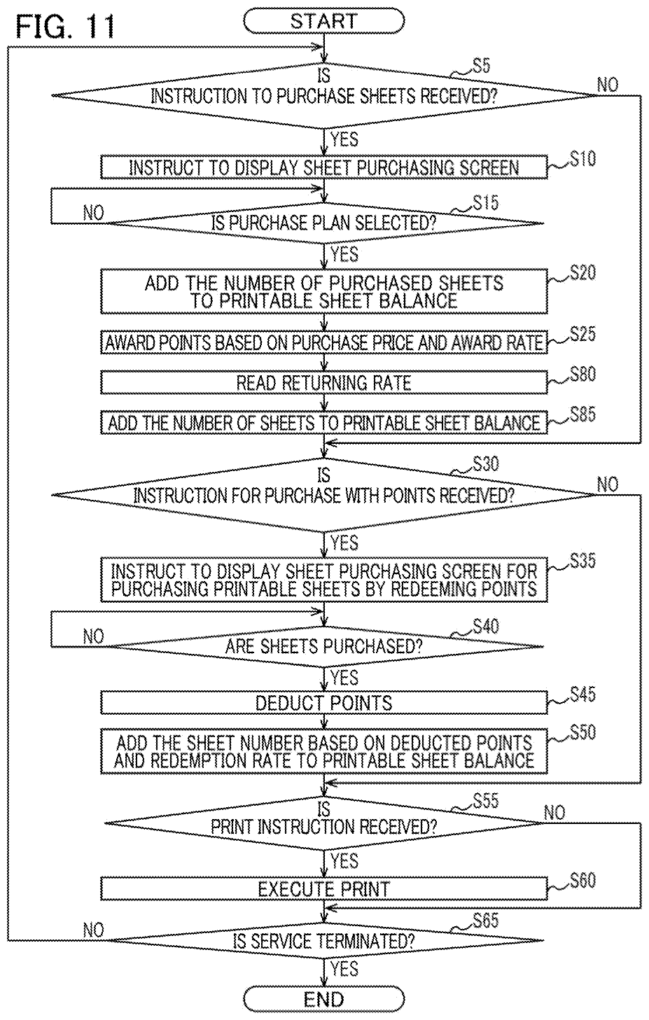

FIG. 11 is a flowchart illustrating an example of a control process executed by the controller of the management server.

Overall Configuration of Printing Service Provision System

FIG. 1 shows the overall configuration of a sample printing service provision system 1 that provides a prepaid printing service. As shown in FIG. 1, the printing service provision system 1 has a management server 100, a printing device 200, a mobile terminal 300, and a transaction server 400. The management server 100, the printing device 200, the mobile terminal 300, and the transaction server 400 are interconnected over a network NT and can communicate with each other. The management server 100 is an example of the server. The mobile terminal 300 is an example of the terminal.

### Management Server

The management server 100 is installed and managed by the manufacturer of the printing device 200, for example. The management server 100 has a controller 110, a storage 115, and a communication interface 190. The controller 110, the storage 115, and the communication interface 190 are interconnected via a bus 105 so as to be capable of exchanging information with each other. The controller 110 is an example of a processor, a computer, and a control device. The communication interface 190 is an example of a communication device, a network interface, an inter-device interface, and a data-exchange device.

The storage 115 is configured of RAM, ROM, EEPROM, a hard disk drive, and the like, for example. The storage 115 stores various programs 120, and various data 130. The various programs 120 include a program for providing a prepaid printing service according to the present embodiment based on the flowcharts shown in FIGS. 9 and 10 and the like. The data 130 includes correlation information correlating numbers of printable sheets for purchase (purchase plans), which are the numbers of sheets the printing device 200 can print on printing sheet (paper), with the prices for purchasing those numbers of sheets. The correlation information further correlates the numbers of printable sheets (purchase plans) with the numbers of points for purchasing the corresponding numbers of sheets as shown in FIG. 8. The correlation information is stored in the form of a table, for example. The printable sheet is an example of the print resource related to the print medium, and thus the correlation information correlates a specific amount of print resources with a specific purchase price for which the specific amount can be purchased.

Printing and purchasing are performed and counted in units of sheets. That is, the sheets are the units of printing (printing units). The number of purchased sheets is an example of the usable amount for printing, the printable amount of medium, or the amount of print resources. However, the printing units are not limited to sheets but may be pages. In a case that the units of printing are printable sheets, one sheet printed on both sides is counted as one sheet, whereas in a case that the printing units are pages, one sheet printed on both sides is counted as two pages. Printing both sides of small print media, such as postcards, New Year's cards, stickers, and business cards, for example, may be counted as one page.

The controller 110 is a device such as a CPU that performs data processing. The controller 110 executes the various programs stored in the storage 115. The controller 110 implements various processes including data communication with the printing device 200, the mobile terminal 300, and the transaction server 400 connected to the network NT. The controller 110 also executes processes related to the prepaid printing service provided by the printing service provision system 1 in conjunction with the printing device 200, the mobile terminal 300, and the transaction server 400.

The communication interface 190 is connected to the network NT and communicates with other devices.

### Printing Device

The printing device 200 is owned by a user receiving the prepaid printing service provided by the printing service provision system 1. The printing device 200 has a controller (processor, computer) 210, a storage 215, a display 240, an operation interface (input interface) 250, a communication interface (a communication device, a network interface, inter-device interface, and data-exchange device) 270, and a printing portion (printing engine, printing mechanism) 290. The controller 210, the storage 215, the display 240, the operation interface 250, the communication interface 270, and the printing portion 290 are interconnected via a bus 205 and can exchange information with each other.

The storage 215 stores various programs 220 including a printing program, for example, and various data 230 including image data to be printed, for example.

The controller 210 is a device such as a CPU that performs data processing. The controller 210 executes various programs stored in the storage 215.

The display 240 is a liquid crystal display, for example, that can display various information. The operation interface 250 is configured of a keyboard and buttons, for example, and receives input operations from the user. By operating the operation interface 250, the user can input various instructions into the printing device 200. The communication interface 270 is connected to the network NT and communicates with other devices.

The printing portion 290 conveys printing sheet with a conveying mechanism (not shown) while printing an image on the printing sheet according to the inkjet method, for example. The printing device 200 has ink tanks that can be filled with ink from bottles, for example. The printing portion 290 prints images on printing sheet using ink from the ink tanks based on a print job received from the mobile terminal 300 or a print job that the printing device 200 (controller 210) generated in response to operations on the operation interface 250. The printing sheet is an example of the printing medium. The printing device 200 is not limited to a tank system provided with the ink tanks described above but may have a cartridge system using interchangeable cartridges. The printing portion 290 may have a print head for ejecting inks.

### Mobile Terminal

The mobile terminal 300 is a smartphone or other mobile device owned by the user, for example. The mobile terminal 300 is connected to the network NT through wireless communication. While not shown in the drawings, the mobile terminal 300 has a controller (a computer, or a processor), a storage, and a communication interface for connecting to the network NT.

The storage of the mobile terminal stores various programs. The programs include various programs related to the provision of the prepaid printing service of the present embodiment, including a program for implementing data communication with the management server 100, the printing device 200, and the transaction server 400 connected to the network NT. The controller executes the various programs stored in the storage and implements processes related to the prepaid printing service provided by the printing service provision system 1 of the present embodiment in conjunction with the management server 100, the printing device 200, and the transaction server 400.

The mobile terminal 300 is configured of a touchscreen integrally combining a liquid crystal display with a touch panel and can display various information and receive various operations inputted by the user. By operating the touchscreen, the user can input various instructions into the mobile terminal 300. Other information terminals, such as a tablet computer or a desktop computer, may be used in place of the mobile terminal 300.

### Transaction Server

The transaction server 400 provides various online services for settling online payments, for example. Although not shown in the drawings, the transaction server 400 has a controller, a storage, and a communication interface for connecting to the network NT.

### Details of Prepaid Printing Service

FIG. 2 shows an example of the prepaid printing service provided by the printing service provision system 1. The example shown in FIG. 2 envisions a single printing device 200 installed in a household configured of Users A, B, and C who share use of the printing device 200. As shown in FIG. 2, when User A purchases a prescribed number of sheets using the mobile terminal 300, for example, the number of purchased sheets is added to a printable sheet balance in the printing device 200. The controller 110 of the management server 100 stores the printable sheet balance for the printing device 200 in the storage 115. Each of the Users A, B, and C can use the printing device 200 within the range of this printable sheet balance. Under these circumstances, the controller 110 of the management server 100 implements a printing process to execute prints on the printing device 200 on the basis of the printable sheet balance which is a remaining number of sheets among a cumulative number of printable sheets that has been purchased using the correlation information that associates the numbers of sheets with the prices (purchase amounts).

When User A purchases sheets, points are also awarded at a prescribed award rate (point award rate) of the purchase amount. The award rate is an example of the variable rate. Here, the controller 110 of the management server 100 executes a first allocation process to allocate the number of points determined by the product of the award rate and the purchase amount. The award rate may be given as a percentage, such as 10%, which is a ratio expressed as a fraction of 100, or may be given in decimal form, such as 0.1, which is a ratio expressed as a fraction of 1. The awarded points are linked to the printing device 200 and accumulated as points (point balance) for the printing device 200.

User A can also purchase printable sheets by using the mobile terminal 300 to redeem a prescribed number of points for the printing device 200 at a prescribed redemption rate. This number of purchased sheets is added to the printable sheet balance on the printing device 200. The redemption rate is an example of the variable rate and an example of the redemption rate. Here, the controller 110 of the management server 100 executes a redemption process to return a variable percentage of the points that the user sets to the user as a reward. While the reward provided the user in the present embodiment is described as the number of printable sheets added to the printable sheet balance, the reward is not limited to this example but may be in the form of money, various services, and various products, for example. The reward may be bonuses, or may be print resources, gifts, or merchandise. The redemption rate may be given as a percentage, such as 10%, which is a ratio expressed as a fraction of 100, or may be given in decimal form, such as 0.1, which is a ratio expressed as a fraction of 1.

Usage information for Users A, B, and C regarding their use of the printing device 200 is accumulated in the storage 215 of the printing device 200, for example, and acquired by the controller 110 of the management server 100. The usage information is provided in the storage 215 so that the single usage information is used by all Users (A, B, and C, in this example) using the printing device 200. However, different usage information may be separately provided for each of the Users A, B, and C. Here, the controller 110 of the management server 100 executes an acquisition process to acquire the usage information from the printing device 200 connected to the communication interface 190 for users using the printing device 200. In a case that the usage information is separately provided for each of the Users A, B, and C, the controller 110 may acquire the usage information for each of the Users A, B, and C, and combine all the acquired usage information to generate usage information for a group of all the users using the printing device 200. The usage information for each printing device 200 may be accumulated in the storage 115 of the management server 100, and the accumulated information is managed by the management server 100.

The usage information includes consumption information pertaining to consumables in the printing device 200. The consumption information is typically information related to printing operations, such as ink consumption, coverage, and the like. The coverage, also called the coverage ratio, is the percentage of the print area on a page that is printed. The coverage is calculated from the actual amount of ink consumption, assuming that ink consumption would be 100% if the entire printable area of one page is printed in a single color. That is, the coverage is a ratio of a total printed area to a total entire printable area in sheets for printings which have been performed for a prescribed period. As an example, ink consumption is not very high when cards having small surface areas such as postcards are being printed, even when coverage is high. The ink consumption may be represented as a ratio of an amount of ink that has been consumed for a prescribed period to a prescribed reference amount, and may be given as a percentage. Thus, ink consumption and coverage are indicators (indexes) which do not necessarily have the same behavior in response to the same printing behavior. That is, the trend variation of the ink consumption and that of the coverage are different for the same printing condition, and thus the ink consumption and the coverage are different kinds of printing indicators.

Note that the consumption information may include information unrelated to printing operations, such as the number of times cleaning with manual purge was performed and the like. Further, the consumption information is not limited to consumption amounts that increase with consumption but may include residual amounts that decrease with consumption. The consumption information used when executing a rate determining process described later may be the cumulative value or average value from the time the printing device 200 was manufactured or put into use, or may be the cumulative value or average value during a predetermined period in the past. The predetermined period may be one week or one month, for example.

The usage information also includes information based on print settings for the printing device 200. The information based on print settings typically specifies the use/nonuse of an eco-setting for printing, the use/nonuse of double-sided printing, the image quality setting, and the sheet setting, for example. The image quality settings include a photo mode or graphics mode for relatively high image quality, and a document mode or draft mode for relatively low image quality. The sheet settings include relatively high-quality paper such as a glossy paper and a specialty paper, or relatively low-quality paper such as a plain paper, for example. The information based on print settings may be statistical values for a certain period in the past, or statistical values for the period from the point in time the printing device 200 was manufactured or put into use until the point in time the rate determining process described later is executed.

At prescribed timings, at least one of the award rate and redemption rate is modified and updated on the basis of the usage information. Here, the award rate and the redemption rate both may be modified, only the award rate may be modified while the redemption rate is a fixed value, or only the redemption rate may be modified while the award rate is a fixed value. The prescribed timings may be timings at which the controller 110 of the management server 100 acquires usage information, periodic timings such as weekly or monthly, or timings at which the user purchases printable sheets, for example. The controller 110 of the management server 100 executes the rate determining process to determine a variable percentage, which can take different values for different cases, such as a case that the usage information indicates a first state and a case that the usage information indicates a second state different from the first state. The expression “award rate/redemption rate” in the following description will be used to mean at least one of the award rate and the redemption rate. The storage 115 stores in advance an initial award rate and an initial redemption rate. When the award rate and the redemption rate are updated (or calculated), the controller 110 stores the updated award rate and the updated redemption rate in the storage 115.

For example, the controller 110 of the management server 100 sets the award rate/redemption rate to a smaller value when the consumption amount of consumables is larger. Specifically, the controller 110 increases the award rate/redemption rate as the value of coverage or ink consumption decreases, and decreases the award rate/redemption rate as the value of coverage or ink consumption increases. This action gives the user an incentive to avoid a reduction in the award rate or redemption rate and can encourage users to minimize the consumption of consumables.

The controller 110 also decreases the award rate/redemption rate for higher image quality settings, for example. Specifically, the controller 110 increases the award rate/redemption rate when the image setting is the relatively low image quality mode such as a document mode and a draft mode, and decreases the award rate/redemption rate when the image setting is the relatively high image quality mode such as a photo mode and a graphics mode. This action can give the user an incentive to avoid a reduction in the award rate or redemption rate by encouraging users to perform low image quality printing as much as possible while avoiding unnecessary high image quality printing.

The controller 110 also decreases the award rate/redemption rate for higher-quality sheet setting, for example. Specifically, the controller 110 increases the award rate or redemption rate when the sheet setting is the relatively low-quality paper such as a plain paper and the like and decreases the award rate or redemption rate when the sheet setting is the relatively high-quality paper such as a glossy paper and a specialty paper. This action can give the user an incentive to avoid a reduction in the award rate or redemption rate by encouraging users to perform low-quality printing as much as possible while avoiding unnecessary high-quality printing.

The controller 110 also increases the award rate/redemption rate for larger percentages of printing using the eco-setting or for larger percentages of printing using double-sided printing. This action can give users an incentive to avoid a reduction in the award rate or redemption rate by encouraging users to maximize printing having low environmental impact and to avoid unnecessarily increasing their impact on the environment.

An upper limit and lower limit are set for the award rate/redemption rate. For example, the upper limit is set to 30% and the lower limit is set to 5% or the like. In the rate determining process described above, the award rate/redemption rate is restricted to the upper limit when exceeding the upper limit and restricted to the lower limit when dropping below the lower limit. By restricting the award rate/redemption rate to a lower limit or upper limit in this way, the award rate/redemption rate may be the same value even when the state of usage information differs between the first state and second state.

Next, a specific example for calculating the award rate or redemption rate in the rate determining process will be described. Here, an example of calculating the award rate will be described, but the same calculation is performed for the redemption rate. When the value of usage information such as the ink consumption or coverage described above is referred to as a usage value, the award rate increases as the usage value decreases. In this case, the modified award rate is calculated using the following Equation (1).

Modified award rate=current award rate+{coefficient of change×(threshold value−usage value)} Equation (1)

The coefficient of change is 0.1 when the award rate is expressed as a percentage (%). The threshold value is 50(%), for example.

Suppose for example that the cumulative average coverage of the printing device 200 used by the user is 30% at a certain point in time. In this case, when the current award rate is 10%, for example, the modified award rate is calculated using the above Equation (1) as follows.

Modified award rate=10+{0.1×(50−30)}=12(%)

Once the award rate has been modified, the modified rate will be applied whenever the user purchases printable sheets. For example, the user will be awarded 12 points when purchasing 100 sheets at 100 yen.

As another example, suppose that the cumulative average coverage of the printing device 200 used by the user is 80% at a certain point in time. In this case, when the current award rate is 10%, for example, the modified award rate is calculated using the above Equation (1) as follows.

Modified award rate=10+{0.1×(50−80)}=7(%)

Once the award rate has been modified, the modified rate will be applied whenever the user purchases printable sheets. For example, the user will be awarded 7 points when purchasing 100 sheets for 100 yen.

The example of the cumulative average coverage 30% is an example of the first state. The example of the cumulative average coverage 80% is an example of the second state.

Further, when the value of usage information, such as the rate of printing with the eco-setting or the rate of printing with the double-sided setting described above, is referred to as the usage value, the award rate increases as the usage value increases. Here, the rate of printing with the eco-setting indicates the ratio of the number of executed print jobs with the eco-setting of the total number of executed print jobs in a certain period, and the rate of printing with the double-sided setting indicates the ratio of the number of executed print jobs with the double-sided setting of the total number of executed print jobs in a certain period, for example. In this case, the modified award rate is calculated according to the following Equation (2).

Modified award rate=current award rate+{coefficient of change×(usage value−threshold value)} Equation (2)

The coefficient of change is 0.1 when the award rate is expressed as a percentage (%). Further, the threshold value is 30(%), for example.

Suppose for example that at a certain point in time while using the printing device 200 the user's rate of printing using the eco-setting over the previous month was 90%. In this case, when the current award rate is 10%, for example, the modified award rate would be calculated using the above Equation (2) as follows.

Modified award rate=10+{0.1×(90−30)}=16(%)

Once the award rate has been modified, the modified rate is applied whenever the user purchases printable sheets. For example, the user is awarded 16 points when purchasing 100 sheets at 100 yen.

As another example, suppose that at a certain point in time while using the printing device 200 the user's rate of printing using the eco-setting used by the user over the previous month was 10%. In this case, when the current award rate is 10%, for example, the modified award rate would be calculated using the above Equation (2) as follows.

Modified award rate=10+{0.1×(10−30)}=8(%)

Once the award rate has been modified, the modified rate is applied whenever the user purchases printable sheets. For example, the user is awarded 8 points when purchasing 100 printable sheets at 100 yen.

The state in which the eco-setting is 90% is an example of the first state, and the state in which the eco-setting is 10% is an example of the second state.

Note that different equations may be applied to the award rate and the redemption rate, such as the above Equation (1) for the award rate and the above Equation (2) for the redemption rate. The following is a specific example of this case. Suppose that both the award rate and the redemption rate have an initial value of 10% in an initial state when the user begins using the printing device 200, for example. When the user purchases 1,000 yen worth of sheets at this time, the user is awarded 100 points. Now suppose that after the user has used the printing device 200 for one month, the cumulative average coverage is 30% and the rate of printing under the eco-setting is 70%. In this case, the award rate modified according to Equation (1) would be 12% and the redemption rate modified according to Equation (2) would be 14%. At this time, when the user purchases an additional 1,000 yen worth of printable sheets, the user would be awarded 120 points, bringing the accumulated points (point balance) for the printing device 200 to 220 points. At this time, when the user redeems 200 points, for example, 28 sheets would be added to the printable sheet balance. The controller 110 of the management server 100 stores the point balance for the printing device 200 in the storage 115. Each of the Users A, B, and C using the printing device 200 can redeem points within the range of the point balance.

Alternatively, two types of variation amounts are calculated according to Equations (3) and (4), in order to calculate the modified award rate and/or the modified redemption rate.

First type variation amount={coefficient of change×(threshold value−usage value)} Equation (3)

Second type variation amount={coefficient of change×(usage value−threshold value)} Equation (4)

In this case, for each kind of data such as the ink consumption and coverage in the usage information, one or more first type variation amounts are calculated, whereas for each kind of data such as the eco-setting and the double-sided setting, one or more second type variation amounts are calculated. The modified award rate is calculated by adding the current award rate to a sum of calculated one or more first type variation amounts and calculated one or more second type variation amounts. The modified redemption rate may be similarly calculated in using Equation (3) and (4). Note that more than two different types of data (consumption, coverage, eco-setting, and double-sided setting) in the usage information may be used for calculating the modified award rate and the modified redemption rate.

The management server 100 stores in the storage 115 data for each of the printable sheet balance, the accumulated points (point balance), the award rate, the redemption rate, and the like described above linked to (in association with) the printing device 200 and manages such data for each printing device 200. These data may also be linked to and managed for a user account instead of linking to the printing device 200. Here, the user account is an account of a user (User A, for example) who represents all the users using the printing device 200. Alternatively, the data may also be linked to and managed for a user account of each user using the printing device 200.

### Sample Screens Displayed on the Mobile Terminal

FIGS. 3 through 8 show sample screens displayed on the touchscreen of the mobile terminal 300. The management server 100 sends instructions and data to display each of the screens shown in FIGS. 3-8 to the mobile terminal 300, and the mobile terminal 300 displays the screens according to the received instructions from the management server 100.

FIG. 3 shows an example of a sheet purchasing screen for purchasing printable sheets. The example shown in FIG. 3 provides various purchase plans of 100 sheets, 200 sheets, 500 sheets, and the like. Prices for these purchase plans (purchase amounts) are set to 100 yen, 180 yen, 300 yen, and the like, respectively. For each plan, the number of sheets and the price (purchase amount) are associated with each other in the correlation information described above. The user can select a desired number of sheets and purchase the sheets using the online payment service provided by the transaction server 400. The sheet purchasing screen also displays the current point award rate. In this example, the award rate is 30%. Therefore, when the user purchases 100 sheets at 100 yen, for example, the user is awarded 30 points. The sheet purchasing screen also includes an Award Rate Breakdown button 301 that the user can operate to confirm the details of how the current award rate is determined (see FIG. 5 described later).

FIG. 4 is an example of a usage/purchase history screen for displaying usage history of the numbers of sheets printed on the printing device 200, and the purchase history of purchasing printable sheets. In the example shown in FIG. 4, the printing device 200 was used to print 10 sheets, 50 sheets, 60 sheets, and 70 sheets during the respective months November 2021, December 2021, January 2022, and February 2022, and the user purchased 100 sheets, 10 sheets, 200 sheets, and 50 sheets in those same months. The usage/purchase history screen also displays the current point award rate. By operating the Award Rate Breakdown button 301, the user can confirm the details with which the current award rate was determined (see FIG. 5 described later).

FIG. 5 is an example of a point award rate breakdown screen that displays a breakdown of the award rate. This screen is displayed when the user operates the Award Rate Breakdown button 301 in the sheet purchasing screen of FIG. 3 or the usage/purchase history screen of FIG. 4. In the example of FIG. 5, the base setting for the award rate is 10%, for example, and the award rate has been increased 1% because the eco-setting was used for 60% of prints during a certain period in the past. The award rate has been further increased by 2% because the cumulative average coverage since the printing device 200 was manufactured or put into use is 30%. Further, the award rate was decreased by 1% since manual purges for cleaning were performed 30 times over the last month. The user can confirm that the current award rate has been set to 30% as a result of totaling the above items and other increases and decreases. These increases and decreases may be calculated by using Equations (3) and (4). The point award rate breakdown screen also displays a message asking whether the user wishes to see how to increase this point award rate and a Yes button 302 and a No button 303 by which the user can reply to this query. By operating the Yes button 302, the user can see how to increase the point award rate (see FIG. 6 described next).

The screen in FIG. 6 displays ways that the user can increase the point award rate. This screen is displayed when the user operates the Yes button 302 in the point award rate breakdown screen of FIG. 5. Ways for increasing the point award rate displayed in the example of FIG. 6 include avoid printing solid areas, use the eco-setting, and perform double-sided printing in order to reduce coverage and ink consumption.

FIG. 7 shows a sample screen displayed in a case that the award rate is at the upper limit when the user operates the Yes button 302 in the point award rate breakdown screen of FIG. 5. The screen shown in FIG. 6 is displayed when the award rate has not reached the upper limit. The example shown in FIG. 7 indicates that the user's current usage is OK as the user is already following the recommended methods of avoiding printing solid areas, using the eco-setting, printing the double-sided printing setting, and the like.

FIG. 8 is an example of a sheet purchasing screen for purchasing printable sheets by redeeming points. The example shown in FIG. 8 offers purchase plans of 10 sheets, 20 sheets, 50 sheets, and the like and lists the numbers of points required to corresponding purchase plans at 100, 200, and 500 sheets. The sheet count in each plan and the number of points required are correlated in the correlation information described above. In other words, in the correlation information, for each plan the number of sheets is determined by a product of the corresponding number points and the rate of 10% which is an initial and base rate in the embodiment. By selecting a desired plan, the user can purchase a desired number of printable sheets using the corresponding number of points. The sheet purchasing screen for purchasing sheets by redeeming points also displays the current point balance for the printing device 200 and the current redemption rate. Since the redemption rate is 11% in this example, 11 sheets are added to the printable sheet balance when the user uses 100 points, for example. The sheet purchasing screen for purchasing sheets by redeeming points also includes a Redemption Rate Breakdown button 304. By operating the Redemption Rate Breakdown button 304, the user can display a redemption rate breakdown screen similar to the screen in FIG. 5 described above in order to confirm the details of how the current redemption rate has been set.

In a case that the redemption rate is 11%, as in the example of FIG. 8, the number of sheets the user obtains is increased according to this redemption rate so that the user obtains 11 sheets by using 100 points and 22 sheets by using 200 points according to the redemption rate being applied. This process may be implemented by first increasing the user's point balance from 500 to 555 before points are used or by using points after decreasing the number of points required for each purchase plan according to the redemption rate.

While not shown in the drawings, the mobile terminal 300 may display screens related to the redemption rate that are similar to the screens for the award rate described above, such as a purchase history screen, a redemption rate breakdown screen, and a screen showing ways to increase the redemption rate.

Either the award rate or the redemption rate is displayed in each of the above-described sheet purchasing screen, usage/purchase history screen, and sheet purchasing screen for purchasing sheets by redeeming points. In order to display these screens on the touchscreen of the mobile terminal 300, the controller 110 of the management server 100 executes a display information transmission process to transmit display data of the screens presenting the variable percentage to the mobile terminal 300, which is connected to the communication interface 190 via the network NT.

### Control Process of the Management Server

FIGS. 9 and 10 show an example of steps in a control process executed by the controller 110 of the management server 100.

In S5 at the beginning of FIG. 9, the controller 110 of the management server 100 determines whether an instruction to purchase printable sheets was received from the user via the mobile terminal 300. When the controller 110 determines no purchase instruction was received (S5: NO), the controller 110 advances to S30 described later. However, when the controller 110 determines that an instruction to purchase printable sheets was received (S5: YES), the controller 110 advances to S10.

In S10 the controller 110 transmits to the mobile terminal 300 an instruction and data to display the sheet purchasing screen (FIG. 3) on the touchscreen of the mobile terminal 300. The process of S10 is an example of the display information transmitting process.

In S15 the controller 110 determines whether the user selected one of the purchase plans in order to purchase printable sheets. The controller 110 continues to wait at step S15 until a purchase plan is purchased (S15: NO). When the controller 110 determines that a purchase plan was purchased (S15: YES), the controller 110 advances to S20.

In S20 the controller 110 adds the number of purchased sheets of the purchased plan determined in S15 to the printable sheet balance in the target printing device 200 to update the printable sheet balance.

In S25 the controller 110 reads the award rate for the target printing device 200 from the storage 115, determines the number of award points to be awarded on the basis of the purchase price of the plan and the award rate. That is, the controller 110 determines the number of points to be awarded to the printing device 200 by using (on the basis of) the product of the purchase price and the award rate. Thus, the controller 110 awards these points to the printing device 200 (or, the account of the representative user of the printing device 200). That is, the controller 110 add the determined points to the point balance of the printing device 200. The award rate read from the storage 115 may be modified in the rate determining process described later or may be a fixed value that is not subjected to the rate determining process. The process of S25 is examples of the first awarding process and step. The process of S25 executed with the fixed award rate is an example of the second award process.

In S30 the controller 110 determines whether an instruction and data to purchase sheets with points was received from the user via the mobile terminal 300. When the controller 110 determines that an instruction to purchase sheets with points was not received (S30: NO), the controller 110 advances to S55 described later. However, when the controller 110 determines that an instruction to purchase sheets with points was received (S30: YES), the controller 110 advances to S35.

In S35 the controller 110 transmits to the mobile terminal 300 an instruction and data to display the sheet purchasing screen for purchasing printable sheets by redeeming points on the touchscreen of the mobile terminal 300 (see FIG. 8). The process of S35 is an example of the display information transmitting process.

In S40 the controller 110 determines whether the user selected one of the purchase plans to purchase sheets with points. In other words, the controller 110 receives a user's selection of the number of sheets to be purchased and the corresponding number of points to be used. The controller 110 waits at step S40 until the user has purchased a plan with points (S40: NO). Once the controller 110 determines that the user has purchased a plan with points (S40: YES), the controller 110 advances to S45.

In S45 the controller 110 deducts the number of points correlated with the purchase plan from the point balance for the target printing device 200. In other words, in S45 the controller 110 sets the points to be withdrawn or deducted from the point balance, and deducts the set point from the point balance.

In S50 the controller 110 reads the redemption rate for the target printing device 200 from the storage 115, determines (calculates) the number of printable sheets on the basis of both the number of points used in S45 and the redemption rate, and adds this sheet number to the printable sheet balance for the printing device 200 (or, the account of the representative user of the printing device 200). That is, the number of print sheets to be added the printable sheet balance is determined by the product of the redemption rate and the number of points used in S45. The redemption rate read from the storage 115 may be modified through the rate determining process described later or may be a fixed value that is not subjected to the rate determining process. The process of S50 to redeem the points on the basis of the variable redemption rate is examples of the redemption process and step.

In S55 the controller 110 determines whether a print instruction was received from the user via the mobile terminal 300. When the controller 110 determines that no print instruction was received (S55: NO), the controller 110 advances to S65 described later. However, when the controller 110 determines that a print instruction was received (S55: YES), the controller 110 advances to S60.

In S60 the controller 110 executes print on the printing device 200 specified by the print instruction within the range of the printable sheet balance for the printing device 200. In other words, the controller 110 executes printing the number of sheets on the printing device 200 while withdrawing (deducting or consuming) the number of sheets from the printable sheet balance. That is, the controller 110 withdraws (deducts) the number of sheets from the printable sheet balance and executes the printing the number of sheets equivalent to the withdrawn number of sheets from the printable sheet balance. In other words, the controller 110 controls the printing device to perform printing the number of sheets, and subtracts the number of printed sheets from the printable sheet balance. The process of S60 is an example of the printing process. When the number of sheets to be printed exceeds the printable sheet balance for the printing device 200, the controller 110 may display, on the touchscreen of the corresponding user's mobile terminal, a message indicating that the number of sheets to be printed exceeds the printable sheet balance for the printing device 200 and a message to prompt the user to purchase another purchase plan.

In S65 the controller 110 determines whether to terminate provision of the prepaid printing service. When provision of the prepaid printing service is not to be terminated (S65: NO), the controller 110 returns to S5 described above. However, when provision of the prepaid printing service is to be terminated (S65: YES), the controller 110 ends the control process of FIG. 9.

FIG. 10 shows an example of the rate determining process for setting the award rate/redemption rate. The target of modification in this rate determining process may be one or both of the award rate and the redemption rate. When modifying only the award rate, the redemption rate is fixed. When modifying only the redemption rate, the award rate is fixed. When the redemption rate is fixed, the redemption rate is not subjected to this rate determining process. Likewise, when the award rate is fixed, the award rate is not subjected to this rate determining process. The expression “award rate/redemption rate” in this embodiment is intended to mean at least one of the award rate and redemption rate. The controller 110 of the management server 100 executes this rate determining process at prescribed timings. As described above, the prescribed timings may be periodic timings, such as weekly or monthly, or may be timings at which the user purchases purchase plans (the numbers of printable sheets). For example, the prescribed timing is in between the process of S15 and S20, or immediately after the process of S50.

In S110 of FIG. 10, the controller 110 of the management server 100 acquires the current award rate/redemption rate for the target printing device 200 by reading the rate from the storage 115, for example. Here, the award rate/redemption rate is subjected to the rate determining process.

In S120 the controller 110 acquires the usage information for the target printing device 200. In other words, in S120 the controller 110 acquires the usage information for the account of the user representing the printing device 200 (User A, for example). In a case that the usage information is separately provided for each of the Users A, B, and C, the controller 110 may acquire the usage information for each of the Users A, B, and C, and combine data included in all the acquired usage information. The process of S120 is examples of the acquisition process and step.

In S130 the controller 110 calculates a new award rate/redemption rate according to Equation (1) or Equation (2) described above on the basis of both the current award rate/redemption rate acquired in S110 and the usage information acquired in S120. The controller may calculate the award rate/redemption rate by using Equation (3) or/and Equation (4).

In S140 the controller 110 determines whether the award rate/redemption rate calculated in S130 falls below the lower limit or exceeds the upper limit. When the calculated award rate/redemption rate neither falls below the lower limit nor exceeds the upper limit (S140: NO), the controller 110 advances to S160 described later. However, when the calculated award rate/redemption rate either falls below the lower limit or exceeds the upper limit (S140: YES), the controller 110 advances to S150.

In S150 the controller 110 restricts the award rate/redemption rate to the lower limit when the rate is below the lower limit, and restricts the award rate/redemption rate to the upper limit when the rate exceeds the upper limit.

In S160 the controller 110 sets the award rate/redemption rate calculated in S130 or the award rate/redemption rate restricted to the lower limit or upper limit in S150 as the new award rate/redemption rate and stores this new award rate/redemption rate in the storage 115. This completes the process of FIG. 10.

The processes S130-S160 are examples of the determining process and step to determine a variable rate (the award rate/redemption rate) so that the variable rate varies between when the usage information indicates the first state and when the usage information indicates the second state.

### Effects of the Embodiment

In the printing service provision system 1 of the present embodiment, the management server 100 is connected to the printing device 200. Under a condition that a user purchases printable sheets for the printing device 200, the controller 110 of the management server 100 performs a print on the printing device 200 through the printing process. Correlation information stored in the storage 115 of the management server 100 in advance correlates different purchase plans for purchasing printable sheets on the printing device 200 and their corresponding purchase prices for the user. In the printing process, the controller 110 performs a print on the basis of the number of purchased sheets associated with the purchase price paid by the user.

The controller 110 of the management server 100 performs the process in S25 to award points for the user's purchase at the prescribed award rate, and the process in S50 to redeem points for a quantity of purchased sheets at the prescribed redemption rate. At least one of the award rate and the redemption rate is modified based on the user's usage information for the printing device 200. The controller 110 of the management server 100 acquires this usage information from the printing device 200 in S120. The controller 110 changes the value for each of the award rate and redemption rate so that the value when the usage information indicates the first state is different from the value when the usage information indicates the second state.

According to the present embodiment, the point award rate and the redemption rate can be adjusted (increased or decreased) when details of the user's usage information on the printing device 200 have changed. In this way, the management server 100 can flexibly implement a benefit provision service on the basis of the user's usage information on the printing device 200.

The controller 110 of the management server 100 may perform at least step S25 among steps S25 for awarding points by using a variable award rate and step S50 for redeeming points by using a variable redemption rate. With this configuration, the management server 100 can adjust (increase or decrease) the award rate for awarding points for a purchase amount on the basis of changes in the user's usage information on the printing device 200. In this way, the management server 100 can flexibly implement a benefit provision service on the basis of the user's usage information on the printing device 200.

The controller 110 of the management server 100 may perform at least step S50 among steps S25 for award points using a variable award rate and step S50 for redeeming points using a variable redemption rate. With this configuration, the management server 100 can adjust (increase or decrease) the redemption rate for points in response to changes in the user's usage information on the printing device 200. In this way, the management server 100 can flexibly implement a benefit provision service on the basis of the user's usage information on the printing device 200.

The controller 110 of the management server 100 may perform the process in S25 to award points using a fixed award rate rather than a variable award rate in return for a purchase amount. In this case, the controller 110 may set a redemption rate in steps S130-S160 to specify a different rate so that the rate at a time that the usage information indicates the first state is different from the rate at a time that the usage information indicates the second state. Here, the redemption rate is a ratio of purchased (or provided) printable sheets to the number of points being redeemed. In this case, in S50 the controller 110 may redeem points, which were awarded at the fixed award rate, for printable sheets according to the variable redemption rate. In this way, the user can use accumulated points (point balance) for executing subsequent prints on the printing device 200. Further, the number of printable sheets to be acquired by redeeming points varies (increases or decreases) when details of the user's usage information on the printing device 200 change. In this way, the management server 100 can flexibly implement a benefit provision service on the basis of the user's usage information for the printing device 200.

Another feature of the present embodiment is that the usage information includes consumption information for consumables, and the management server 100 can provide flexible benefits on the basis of this usage information for the printing device 200 according to the consumption states of consumables.

Another feature of the present embodiment is that in S130-S160 the management server 100 decreases at least one of the award rate and redemption rate as the consumption of consumables increases. Thus, the management server 100 can give users an incentive to avoid decreases in the award rate or redemption rate and can encourage users to minimize the consumption of consumables.

Another feature of the present embodiment is that in S130-S160 the management server 100 decreases at least one of the award rate and redemption rate as the value for coverage increases. Thus, the management server 100 can give users an incentive to avoid decreases in the award rate or redemption rate and can encourage users to minimize printing with a large amount of coverage.

Another feature of the present embodiment is that the usage information includes information on the print settings, and the management server 100 can provide flexible benefits on the basis of this usage information for the printing device 200 according to the states of print settings based on the usage information.

Another feature of the present embodiment is that in S130-S160 the management server 100 decreases at least one of the award rate and redemption rate on the basis of the image quality setting used for printing. Thus, the management server 100 can give users an incentive to avoid decreases in the award rate or redemption rate and can encourage users to carefully consider image quality when printing.

Another feature of the present embodiment is that in S130-S160 the management server 100 decreases at least one of the award rate and redemption rate for higher quality image settings. Thus, the management server 100 can give users an incentive to avoid decreases in the award rate or redemption rate and can encourage users to print as much as possible at a low quality while avoiding unnecessary high-quality printing.

Another feature of the present embodiment is that in S130-S160, the management server 100 adjusts at least one of the award rate and redemption rate on the basis of usage information within a specific period included in the usage information acquired in S120. In this way, the management server 100 can flexibly implement a benefit provision service on the basis of the user's usage information for the specific period for the printing device 200.

Another feature of the present embodiment is that by displaying display data in S10 and S35, the management server 100 can present the award rate and redemption rate to the user on the mobile terminal 300. In this way, by making the user aware of the award rate or redemption rate for the user's own points, the management server 100 can give the user motivation to gain benefits by increasing the award rate or redemption rate instead of losing benefits due to a decrease in the award rate or redemption rate.

### Variations

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, the management server 100 may provide the benefit through a providing process of S80 and S85 as well as the allocation process of S25 and the redemption process of S50 as shown in FIG. 11. In this case, the management server 100 performs the providing process to additionally supply (returns) the number of printable sheets in return for purchasing the number of printable sheets using the purchase amount. The control process of FIG. 11 is the same as the control process shown in FIG. 9, except that the control process of FIG. 11 performs steps S80 and S85, as the providing process, after performing the step S25 and before performing the step S30. Steps identical to those in the control process shown in FIG. 9 are designated with the same step numbers. The storage 115 stores a returning rate to be used in the providing process, similarly to the award rate and the redemption rate.

In S80 the controller 110 reads the returning rate for the target printing device 200 and calculates the number of sheets to be additionally provided for the printing device 200 (or, the account of the representative user of the printing device 200) by calculating a product of a returning rate and the price for purchasing the number of sheets. That is, the number of sheets to be supplied is determined from the product of the returning rate and the price (purchase amount). Here, the returning rate is a variable rate determined in the rate determining process shown in FIG. 10. The returning rate may be equal to the redemption rate used in S50 or may be different from the awarding rate and from the redemption rate. Alternatively, the returning rate may be a fixed rate.

In S85 the controller adds the number of sheets calculated in S80 to the printable sheet balance for the printing device 200 (or, the account of the representative user of the printing device 200). Accordingly, the management server 100 provides the benefit through the providing process of S80 and S85 as well as the allocation process of S25 and the redemption process of S50. The number of sheets added to the printable sheet balance is an example of the amount of second reward. However, the second reward may in the form of money, various services, and various products, for example. The reward may be bonuses, or may be print resources, gifts, or merchandise.

While the control process shown in FIG. 11 describes a case of executing the providing process for additionally supplying the number of sheets, the allocation process for awarding points, and the redemption process for redeeming points, the present invention is not limited to this method. However, the management server 100 may execute only the providing process but execute neither the awarding process nor the redemption process, in the control process shown in FIG. 11. In this case, in the control process shown in FIG. 11 is modified, so that the controller 110 performs only steps S5, S10, S15, S80, S85, S55, S60, and S65, but performs none of steps S20, S25, S30, S35, S40, S45, and S50. Accordingly, the management server 100 returns printable sheets to the printing device 200 (or the account of the representative user of the printing device 200) for the purchase amount while calculating the printable sheets to be returned by using (or, on the basis of) a product of a prescribed redemption rate and the price (purchase amount). In this case, some of the purchase amount can be returned as the additional sheets using a returning rate that varies on the basis of usage information. Alternatively, the management server 100 may refund (cash-back) an amount of cash from among the purchase amount, rather than awarding points as the providing process. For example, the amount of cash to be refund may be determined with a product of the purchase amount (price) and the returning rate which is determined in the rate determining process (FIG. 10). This corresponds to a feature known as cash back.

In the embodiments, the awarding rate and the redemption rate are provided for each printing device 200. However, the awarding rate and the redemption rate may be provided for each user of each printing device 200. In this case, the management server 100 stores in the storage 115 and manages usage information, the awarding rate, the redemption rate, the printable sheet balance, and the point balance for each user of each printing device 200. In this case, the rate determining process shown in FIG. 9 is executed for each user of each printing device 200 to determine the award rate/redemption rate for that user. In this case, the printable sheet balance and the point balance are managed and used for each individual user of each printing device 200 in the process shown in FIG. 10.

Further, the flowcharts in FIGS. 9 and 10 do not limit the present invention to the steps indicated therein. Steps may be added or deleted, or their order may be rearranged without departing from the spirit and scope of the disclosure.

The technical elements, method, steps, and processes described above in the embodiment and its variations may be used in any suitable combination.

The present invention may be embodied by modifying various elements without departing from the spirit and scope thereof.

What is claimed is:

1. A server comprising:
a communication interface configured to communicate with a printing device;
a storage storing correlation information correlating a specific amount of print resources with a specific price for which the specific amount can be purchased, the specific amount being represented in specific units, the print resources being related to a print medium; and
a computer configured to perform:
a printing process to instruct the printing device to execute printing on a specific unit basis;
acquiring usage information for a user of the printing device from the printing device via the communication interface, the usage information indicating one of a plurality of usage states of the printing device including a first usage state and a second usage state different from the first usage state; and
a benefit provision process to perform at least one of a first process and a second process,
wherein the first process includes:
a first determining process to determine a first variable rate so that the first variable rate varies between when the usage information indicates the first usage state and when the usage information indicates the second usage state; and
an awarding process to award number of points calculated on the basis of a product of the first variable rate and the specific price when the specific amount of print resources is purchased for the specific price,
wherein the second process includes:
a second determining process to determine a second variable rate so that the second variable rate varies between when the usage information indicates the first usage state and when the usage information indicates the second usage state; and
a providing process to provide the user with an amount of reward calculated on the basis of a product of the second variable rate and the specific price when the specific amount of print resources is purchased for the specific price.

2. The server according to claim 1, wherein the benefit provision process at least performs the first process.

3. The server according to claim 1, wherein the benefit provision process at least performs the second process.

4. The server according to claim 1, wherein the storage further stores information on a point balance indicating accumulated points available for the printing device,
wherein the benefit provision process does not perform the first process but performs the second process,
wherein the benefit provision process further performs:
a third process to award number of points calculated on the basis of a product of a fixed rate and the specific price when the specific amount of print resources is purchased for the specific price; and
a fourth process to perform:
a third determining process to determine a third variable rate so that the third variable rate varies between when the usage information indicates the first usage state and when the usage information indicates the second usage state;
setting number of points to be withdrawn from the point balance;
calculating an amount of second reward by using a product of the set number of points and the third variable rate; and
providing the user with the amount of second reward and withdrawing the set number of points from the point balance.

5. The server according to claim 1, wherein the usage information includes consumption information indicating an amount of consumable used in the printing device.

6. The server according to claim 5, wherein the first determining process determines the first variable rate so that the first variable rate decreases as the amount of consumable increases,
wherein the second determining process determines the second variable rate so that the second variable rate decreases as the amount of consumable increases.

7. The server according to claim 1, wherein the usage information includes coverage information indicating a coverage ratio of a printed area to a total printable area,
wherein the first determining process determines the first variable rate so that the first variable rate decreases as the coverage ratio increases,
wherein the second determining process determines the second variable rate so that the second variable rate decreases as the coverage ratio increases.

8. The server according to claim 1, wherein the usage information includes settings information indicating print settings in the printing device.

9. The server according to claim 8, wherein the print settings includes settings of image quality.

10. The server according to claim 9, wherein the first determining process determines the first variable rate so that the first variable rate decreases as the image quality in the print settings increases,
wherein the second determining process determines the second variable rate so that the second variable rate decreases as the image quality in the print settings increases.

11. The server according to claim 1, wherein the usage information is determined by a state of the printing device for a specific period of time,
wherein the first determining process determines the first variable rate so that the first variable rate varies between when the usage information indicates that the printing device is in the first usage state for the specific period and when the usage information indicates that the printing device is in the second usage state for the specific period,
wherein the second determining process determines the second variable rate so that the second variable rate varies between when the usage information indicates that the printing device is in the first usage state for the specific period and when the usage information indicates that the printing device is in the second usage state for the specific period.

12. The server according to claim 1, wherein the communication interface is configured to further communicate with a terminal,
wherein the computer is configured to further perform:
transmitting a display instruction to instruct the terminal to display at least one of the first variable rate and the second variable rate.

13. A method for a print management system storing correlation information correlating a specific amount of print resources with a specific price for which the specific amount can be purchased, the specific amount being represented in specific units, the print resources being related to a print medium, the print management system performing a printing process to instruct the printing device to execute printing on a specific unit basis, the method comprising:
acquiring usage information for a user of the printing device from the printing device via the communication interface, the usage information indicating one of a plurality of usage states of the printing device including a first usage state and a second usage state different from the first usage state; and
a benefit provision process to perform at least one of a first process and a second process,
wherein the first process includes:
a first determining process to determine a first variable rate so that the first variable rate varies between when the usage information indicates the first usage state and when the usage information indicates the second usage state; and
an awarding process to award number of points calculated on the basis of a product of the first variable rate and the specific price when the specific amount of print resources is purchased for the specific price,
wherein the second process includes:
a second determining process to determine a second variable rate so that the second variable rate varies between when the usage information indicates the first usage state and when the usage information indicates the second usage state; and
a providing process to provide the user with an amount of reward calculated on the basis of a product of the second variable rate and the specific price when the specific amount of print resources is purchased for the specific price.

14. A server comprising:
a communication interface configured to communicate with a printing device;
a storage storing:
correlation information correlating a specific amount of print resources with a specific price for which the specific amount can be purchased, the print resources being related to a print medium; and
information on a print resource balance indicating an accumulated amount of print resources available in the printing device, wherein when the specific amount of print resources is purchased, the purchased specific amount is added to the print resource balance; and
a computer configured to perform:
a printing process to instruct the printing device to execute printing on number of printing media while withdrawing an amount of print resources corresponding to the number of printing media from the print resource balance;
acquiring usage information for a user of the printing device from the printing device via the communication interface, the usage information indicating one of a plurality of usage states of the printing device including a first usage state and a second usage state different from the first usage state; and
a benefit provision process to perform at least one of a first process and a second process,
wherein the first process includes:
a first determining process to determine a first variable rate so that the first variable rate varies between when the usage information indicates the first usage state and when the usage information indicates the second usage state; and
an awarding process to award number of points calculated on the basis of a product of the first variable rate and the specific price when the specific amount of print resources is purchased for the specific price,
wherein the second process includes:
a second determining process to determine a second variable rate so that the second variable rate varies between when the usage information indicates the first usage state and when the usage information indicates the second usage state; and
a rewarding process to provide the user with an amount of reward calculated on the basis of the second variable rate.

15. The server according to claim 14, wherein when the specific amount of print resources is purchased for the specific price, the rewarding process provides, as the amount of reward for the purchased specific amount, an amount of print resources calculated on the basis of the second variable rate.

16. The server according to claim 14, wherein the storage further stores information on a point balance indicating accumulated points available for the printing device,
wherein the benefit provision process does not perform the first process but performs the second process,
wherein the rewarding process includes:
setting number of points to be withdrawn from the point balance;
calculating an amount of second reward by using a product of the set number of points and the second variable rate; and
providing the user with the amount of second reward and withdrawing the set number of points from the point balance.
